(19) United States
(12) Patent Application Publication
(10) Pub. No.: US 2023/0172807 A1
(43) Pub. Date: Jun. 8, 2023

(54) INJECTION SITE WITH A MEMBRANE AND A LEAK-FREE REMOVABLE PROTECTION

(71) Applicants: Baxter International Inc., Deerfield, IL (US); Baxter Healthcare SA, Giattpark (Opfikon) (CH)

(72) Inventors: Virgil Claudiu Manta, Overijse (BE); Steve Wasterlain, Herchies (BE); Jean-Claude Bezin, Lessines (BE); Fabio Giuseppe Casartelli, Deleblo-SO (IT); Freddy Desbrosses, Thuin (BE); Michaël Georges, Lobbes (BE); Cécile Marché, Saint-Gilles (BE)

(21) Appl. No.: 17/543,117

(22) Filed: Dec. 6, 2021

(51) Int. Cl. A61J 1/14; A61J 1/20

(52) U.S. Cl. CPC A61J 1/1406; A61J 1/2048

(57) ABSTRACT

A medical device for transferring a fluid from a pharmaceutical flexible container is disclosed. The medical device comprises a top part, a center part, a breakable zone between the top part and the center part and an insert part. The insert part comprises a third enclosure enclosing a second tunnel; and the top side of the third enclosure comprising a membrane, wherein a top surface of the membrane seals the third opening of the second enclosure.

### TECHNICAL FIELD

The disclosure is directed to a medical device for transferring a liquid or a fluid, specifically an injection site (e.g., addition or additive site) used on pharmaceutical flexible containers to perform addition or withdrawal of a liquid or a fluid. More specifically, the injection site comprises both a tamper evident breakable protective cover in order to protect the external surface of the septum from contamination before being used, and a membrane that prevent direct contact of the septum with the liquid or the fluid. Background and Description of the Related Art

Injection sites are used to add micronutrients or medication to a pharmaceutical flexible bag having a liquid by means of a needle piercing though a self-sealing septum component, before administration of the admixed solution. Sometimes, the withdrawal of the liquid from the pharmaceutical flexible bag is also performed the same way through the injection site.

In many cases, the external surface of the self-sealing septum is not protected and therefore, a disinfection of that surface with alcohol or another disinfectant is required before proceeding with the needle insertion. The risk of having microbiological contamination on the external septum surface is however limited when the product is placed in a secondary package before being sterilized. However, this risk is significantly higher if the product is sterilized before adding the secondary packaging. In that case, injection sites with a protective cover are recommended to be used.

Another feature of some injection sites is to have a membrane to prevent direct contact of the self-sealing septum with the solution (i.e., the liquid or the fluid). Such membrane may also enhance the gas permeability properties, reducing the water loss of the liquid or the fluid, and protecting the solution (i.e., the liquid or the fluid) from oxygen transfer. Lastly, this membrane also reduces the risk of having substances leaching from the septum that is usually made from polyisoprene rubber.

However, no existing products include both a removable protection cover and a membrane. Hence, needed in the art is an injection site with a sealed membrane preventing contact between the septum and the solution (i.e., the liquid or the fluid) and a leak-free tamper evident removable protection to protect the external surface of the septum from outside contamination.

### SUMMARY OF THE INVENTION

The present invention provides for an injection site (also called addition or additive site) used on pharmaceutical flexible containers to perform addition or withdrawal of a fluid or a liquid from the pharmaceutical flexible containers. Related embodiments described herein relate to an injection site comprising both a tamper evident breakable protective cover in order to protect the external surface of a septum from contamination before being used, and a membrane that prevents direct contact of the septum with the solution (e.g., the fluid or the liquid).

According to one aspect, the present disclosure relates to a medical device for transferring a fluid from a pharmaceutical flexible container. The medical device comprises a top part, the top part comprising: a first enclosure enclosing a solid body or a hollow body; a center part, the center part comprising: a second opening connecting to the first opening, and the second opening having the second inner diameter; a second enclosure enclosing a first housing having a third inner diameter for holding a septum; a third opening having the third inner diameter; a breakable zone between the top part and the center part; and an insert part, the insert part comprising: a third enclosure enclosing a second tunnel; and the top side of the third enclosure comprising a membrane, wherein a top surface of the membrane seals the third opening of the second enclosure.

In one embodiment, the top part comprises the first enclosure enclosing a first tunnel having a first inner diameter; and a first opening having a gradually enlarging inner diameter from the first inner diameter at a first end of the first opening to a second inner diameter at a second end of the first opening.

In one embodiment, the top part comprises the first enclosure enclosing the solid body; and a first opening having a first inner diameter, wherein the first inner diameter is the same as that of the second inner diameter.

In one embodiment, the first enclosure, the second enclosure and the breakable zone are all made of the same material.

In one embodiment, the first enclosure, the second enclosure and the breakable zone are all made of blends of polyethylene (PE), polypropylene (PP), copolymers of eth-ylene and propylene and mixture with polyolefin elastomers and/or ethylene-vinyl acetate (EVA).

In one embodiment, the first enclosure, the second enclosure and the breakable zone are all made of a blend of polypropylene (PP), Styrene-ethylene-butylene-styrene (SEBS) and ethylene-vinyl Acetate (EVA).

In one embodiment, the septum is a self-sealing septum.

In one embodiment, the septum is made of an elastomeric material selected from the group consisting of polyisoprene, silicone, natural rubber, polychloroprene, nitrile, carboxylated acrylonitrile butadiene rubber, styrene butadiene rubber, butadiene co-polymer, polyurethane, vinyl, and mixtures thereof.

In one embodiment, the septum is made of polyisoprene.

In one embodiment, the second enclosure of the center part comprises a convex structure near the third opening and the convex structure fits in a concave structure on the top surface of the insert part.

In one embodiment, the third inner diameter is greater than the second inner diameter.

In one embodiment, the breakable zone is made of a material stiff enough to allow an easy breakage of the breakable tamper evident cap and ductile enough to prevent the formation of particles after the breakage.

In one embodiment, the top part, the center part and the insert part are molded into a single device.

In one embodiment, the top part, the center part and the insert part are separately molded and assembled into a single device.

In one embodiment, the top part comprises a fin attached to an outside surface of the first enclosure.

In one embodiment, the insert part comprises a flange attached to an outside surface of the third enclosure.

According to another aspect, the present disclosure relates to an injection site. The injection site comprises a top part, the top part comprising: a first enclosure enclosing a first tunnel; a first opening at the bottom of the first enclosure; a center part located inside the first tunnel near the bottom of the first enclosure, the center part comprising: a second enclosure enclosing a first housing for holding a septum; and a membrane at the bottom of the second enclosure; an insert part, the insert part comprising: a third enclosure enclosing a second tunnel; and a second opening at the top of the second tunnel, and a bottom surface of the membrane seals the second opening of the third enclosure; and a breakable zone between the top part and the insert part.

In one embodiment, the first enclosure, the second enclosure and the breakable zone are all made of the same material.

In one embodiment, the first enclosure, the second enclosure and the breakable zone are all made of blends of polyethylene (PE), polypropylene (PP), copolymers of eth-ylene and propylene and mixture with polyolefin elastomers and/or ethylene-vinyl acetate (EVA).

In one embodiment, the first enclosure, the second enclosure and the breakable zone are all made of a blend of polypropylene (PP), Styrene-ethylene-butylene-styrene (SEBS) and ethylene-vinyl Acetate (EVA).

In one embodiment, the septum is a self-sealing septum.

In one embodiment, the septum is made of an elastomeric material selected from the group consisting of polyisoprene, silicone, natural rubber, polychloroprene, nitrile, carboxylated acrylonitrile butadiene rubber, styrene butadiene rubber, butadiene co-polymer, polyurethane, vinyl, and mixtures thereof.

In one embodiment, the septum is made of polyisoprene.

In one embodiment, the breakable zone is made of a material stiff enough to allow an easy breakage of the breakable tamper evident cap and ductile enough to prevent the formation of particles after the breakage. In one embodiment, the top part, the center part and the insert part are molded into a single injection site.

In one embodiment, the top part, the center part and the insert part are separately molded and assembled into a single injection site.

In one embodiment, the top part comprises a fin attached to an outside surface of the first enclosure.

In one embodiment, the insert part comprises a fin attached to an outside surface of the third enclosure.

According to another aspect, the present disclosure relates to a medical device for transferring a fluid from a pharmaceutical flexible container. The medical device comprises a top part, the top part comprising: a first enclosure enclosing a first housing for holding a septum, the first housing having a first opening at the top of the first housing; and a membrane at the bottom of the first enclosure; a lid, the lid sealing the first opening of the first housing; and an insert part, the insert part comprising: a second enclosure enclosing a first tunnel; and a second opening at the top of the first tunnel, and a bottom surface of the membrane seals the second opening of the insert part.

In one embodiment, the septum is a self-sealing septum.

In one embodiment, the septum is made of an elastomeric material selected from the group consisting of polyisoprene, silicone, natural rubber, polychloroprene, nitrile, carboxylated acrylonitrile butadiene rubber, styrene butadiene rubber, butadiene co-polymer, polyurethane, vinyl, and mixtures thereof.

In one embodiment, the septum is made of polyisoprene.

In one embodiment, the top part, the lid and the insert part are molded into a single medical device.

In one embodiment, the top part, the lid and the insert part are separately molded and assembled into a single medical device.

In one embodiment, the insert part comprises a fin attached to an outside surface of the second enclosure.

According to another aspect, the present disclosure relates to a method for transferring a fluid from a pharmaceutical flexible container by using the medical device as discussed above. The method comprises: connecting the medical device with the pharmaceutical flexible container; breaking the top part of the medical device; piecing a needle of a syringe through the septum; and transferring the fluid from the pharmaceutical flexible container.

### BRIEF DESCRIPTION OF THE DRAWINGS

FIG. 1a is a schematic depiction showing a cross-section of a design of the injection site 1100 according to certain embodiments of the present invention, comprising a top part 1101, a center part 1104 holding a septum 1112, a breakable zone 1103 between the top part 1101 and the center part 1104, and an insert part 1106.

FIG. 1b is a schematic depiction showing a cross-section of part of the design of the injection site 1200 according to FIG. 1a of the present invention, comprising a top part 1201, a center part 1204, a breakable zone 1203 between the top part 1201 and the center part 1204.

FIG. 1c is a schematic depiction showing a cross-section of part of the design of the injection site according to FIG. 1a of the present invention, comprising a septum 1300.

FIG. 1d is a schematic depiction showing a cross-section of part of the design of the injection site according to FIG. 1a of the present invention, comprising an insert part 1400.

FIG. 1e is a schematic depiction showing a cross-section of a design of the injection site 1500 according to certain embodiments of the present invention, comprising a top part 1501, a center part 1504 holding a septum 1512, a breakable zone 1503 between the top part 1501 and the center part 1504, and an insert part 1506. Different from the injection site 1100 of FIG. 1a, the top part 1501 of the injection site 1500 comprises an enclosure 1502 enclosing a solid body.

FIG. 2a is a schematic depiction showing a design of the injection site 2100 according to certain embodiments of the present invention, comprising a top part 2101 comprising a fin 2102, a center part 2104 holding a septum (not shown), a breakable zone 2103 between the top part 2101 and the center part 2104, and an insert part 2105 comprising a flange 2106.

FIG. 2b is a schematic depiction showing part of the design of the injection site 2200 according to FIG. 2a of the present invention, comprising a top part 2201 comprising a fin 2202, a center part 2204 holding a septum (not shown), a breakable zone 2203 between the top part 2201 and the center part 2204.

FIG. 2c is a schematic depiction showing part of the design of the injection site 2300 according to certain embodiments of the present invention, comprising a top part 2301, a center part 2302 for holding a septum (not shown), a breakable zone 2303 between the top part 2301 and the center part 2303.

FIG. 2d is a schematic depiction showing a cross-section of part of a design of the injection site 2400 according to certain embodiments of the present invention, comprising a top part 2401, a center part 2402 to hold a septum (not shown), a breakable zone 2403 between the top part 2401 and the center part 2402.

FIG. 2e is a schematic depiction showing a cross-section of part of a design of the injection site 2500 according to certain embodiments of the present invention, comprising a top part 2501, a center part 2502 for holding a septum (not shown), a breakable zone 2503 between the top part 2501 and the center part 2502.

FIG. 3a is a schematic depiction showing a cross-section of part of a design of the injection site 3100 according to certain embodiments of the present invention, comprising a top part 3101 comprising a fin 3102, a center part 3104 to hold a septum (not shown), an insert part 3105, and a breakable zone 3103 between the top part 3101 and the insert part 3105.

FIG. 3b is a schematic depiction showing a cross-section of another design of the injection site 3200 according to certain embodiments of the present invention, comprising a top part 3201 holding a septum 3203, and a lid 3202 covering the septum 3203, and an insert part 3208 including a widened and flattened base 3204 to be sealed directly to a film.

FIG. 3c is a schematic depiction showing a design of the injection site 3300 according to certain embodiments of the present invention, comprising a top part 3301 holding a septum (not shown), and a lid 3302 covering the septum, and an insert part 3303 including a widened and flattened base 3204 to be sealed directly to a film.

### DETAILED DESCRIPTION OF THE INVENTION

The present invention generally relates to the field of medical devices and parenteral nutrition. More particularly, the present invention relates to an injection site (also called addition or additive site) used on pharmaceutical flexible containers to perform addition or withdrawal of a fluid or a liquid from the pharmaceutical flexible containers. Related embodiments described herein relate to an injection site comprising both a tamper evident breakable protective cover in order to protect the external surface of a septum from contamination before being used, and a membrane that prevents direct contact of the septum with the solution (e.g., the fluid or the liquid).

In one embodiment, the pharmaceutical flexible containers are either monobags such as any pharmaceutical flexible bags or multi-chamber bags (MCBs) such as any multi-chamber pharmaceutical flexible bags. In one embodiment, the pharmaceutical flexible containers are multi-chamber bags (MCBs) such as any multi-chamber pharmaceutical flexible bags. The medical devices or injection sites of the present invention can be used to add or withdraw a fluid from the multi-chamber bags (MCBs), or multi-chamber pharmaceutical flexible bags.

In one embodiment, the present medical device/injection site may be used to transfer a fluid of a nutrient, a macronutrient or a micronutrient, a home parenteral nutrition, or a total parenteral nutrition (TPN) or others.

Unless defined otherwise, all technical and sci-entific terms used herein have the same meaning as commonly understood by one of ordinary skill in the art to which this invention belongs. As used herein the following terms have the following meanings.

The expression “comprising” or “comprises,” as used herein, is intended to mean that the compositions and methods include the recited elements, but not excluding others.

The expression “about,” when used before a numer-ical designation, e.g., temperature, time, amount, and con-centration, including range, indicates approximations which may vary by (+) or (−) 10%, 5% or 1%.

As used herein, the expression “injection site” refers to a medical device capable of adding micronutrients or medication to or removing micronutrients or medication from a pharmaceutical flexible bag by means of a needle piercing though a self-sealing septum component, before administration of the admixed solution.

As used herein, the expression “breakable zone” refers to an area of a medical device that can be broken once intended. For example, a breakable zone in a medical device might have a wall thinner than that of other areas.

As used herein, the expression “nutrient” refers to a substance used by an organism, such as a human, to survive, grow, and reproduce. Some nutrients can be metabol-ically converted to smaller molecules in the process of re-leasing energy, such as carbohydrates and lipids. All organ-isms require water. Essential nutrients for animals and humans are the energy sources, some of the amino acids that are combined to create proteins, a subset of fatty acids, vitamins, and certain minerals and trace elements.

A classification used primarily to describe nutrient needs of humans and animals divides nutrients into “macronutrients” and “micronutrients”. Consumed in relatively large amounts, macronutrients are used primarily to generate energy or to incorporate them into tissues for growth and repair. Specifically, the expression “macronutrient” or “macronutrients” refers to nutrients comprising carbohydrates, amino acids, and lipids.

“Micronutrients” are essential elements required by humans in small quantities throughout life for a range of physiological functions to maintain health. In the context of the present invention, the expression “micronutrients” refers to vitamins and trace elements. In the context of the invention, trace elements may be provided, for example, as chloride or sodium salts, as gluconates or sulfates.

The expression “home parenteral nutrition” as used herein means nutrition support of patients who cannot meet their nutritional requirement by oral or enteral intake, and who are able to receive therapy outside the hospital setting. HPN is the primary life-saving therapy for patients with, for example, chronic intestinal failure (CIF). HPN may also be provided as palliative nutrition to patients in late phases of end-stage diseases, including cancer (Pironi et al.: ESPEN guideline on home parenteral nutrition. Clinical Nutrition (2020), 39:1645-1666).

The expression “total parenteral nutrition (TPN)” refers to parenteral nutrition that provides all daily nutritional requirements intravenously to patients who cannot otherwise ingest and/or digest nutrition. TPN can be a short-term or long-term nutritional therapy. “Partial parenteral nutrition (PPN)” refers to parenteral nutrition to patients whose nutritional requirements cannot be fully met via the enteral or oral route. TPN and PPN can be provided to hos-pitalized patients, including patients in intensive care, but also to home parenteral patients, to avoid malnutrition.

As used herein, the expression “multi-chamber bag (MCB)” which is interchangeably used herein with the expression “multi-chamber container”, refers to containers or bags made from a flexible film material and which are compart-mentalized into two or more chambers. They allow for the safe and stable accommodation of medical solutions that must be kept separate until the formulations can be mixed (reconstituted) shortly before their administration to a patient to avoid inevitable reactions between the formulations. Therefore, MCBs have peelable seals or welds (e.g., removable thermo-welds) between the chambers to be reconstituted. The weld or seals can be opened, for example, by squeezing.

As used herein, the expression “polymer” refers to a compound prepared by polymerizing monomers, whether of the same or a different type, that in polymerized form provide the multiple and/or repeating “units” that make up a polymer. The generic term polymer thus embraces the term homopolymer, usually employed to refer to polymers prepared from only one type of monomer, and the term copolymer, usually employed to refer to polymers prepared from at least two types of monomers. It also embraces all forms of copolymer, e.g., random, block, etc. The terms “ethylene/α-olefin polymer” and “pro-pylene/α-olefin polymer” are indicative of copolymer as described above prepared from polymerizing ethylene or propylene respectively and one or more additional, polymerizable α-olefin monomer. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. Trace impurities, such as cat-alyst residues, can be incorporated and present in the polymer.

As used herein, the expression “copolymer” refers to a polymer prepared by polymerizing at least two different types of monomers. The generic term copolymer thus includes polymers made from two different types of monomers, and polymers made from more than two different types of monomers.

As used herein, the expression “polyethylene” refers to a polymer made of at least 50% ethylene-derived units, preferably at least 70% ethylene-derived units, more preferably at least 80% ethylene-derived units, or 90% eth-ylene-derived units, or 95% ethylene-derived units, or even 100% ethylene-derived units. The polyethylene can thus be a homopolymer or a copolymer, including a terpolymer, having other monomeric units. A polyethylene described herein may, for example, include units derived from a co-monomer that is preferably an α-olefin, e.g., propylene, 1-butene, 1-pen-tene, 1-hexene, or 1-octene. Other embodiments may include ethacrylate or methacrylate.

As used herein, the expression “polypropylene” refers to any polymer that, and may include homo, impact, random, and isotactic propylene polymers. Preferably, the polypropylene used in the compositions described herein has a melting point above 110° C., includes at least 90 wt % pro-pylene units, and contains isotactic sequences of those units. Alternatively, the polypropylene may include atactic sequences or syndiotactic sequences. The polypropylene can either derive exclusively from propylene monomers (i.e., having only propylene units) or derive from mainly propylene (more than 80% propylene) with the remainder derived from olefins, particularly ethylene, and/or C₄-C₁₀ α-olefins.

As used herein, the expression “polyolefin elastomer” or “POE” refers to elastomers based on a polyethylene backbone. Ethylene-based POE have 65-91% ethylene and 9-35% linear alpha-olefin such as butene-1, hexene-1, or octene-1. “Polyolefin elastomers” may include, but are not limited to, polyisobutylene (PIB), poly(α-olefin)s, ethylene propylene rubber (EPR), ethylene propylene diene monomer (M-class) rubber (EPDM rubber).

In one aspect, the present invention relates to a medical device/an injection site for transferring a fluid from a pharmaceutical flexible container.

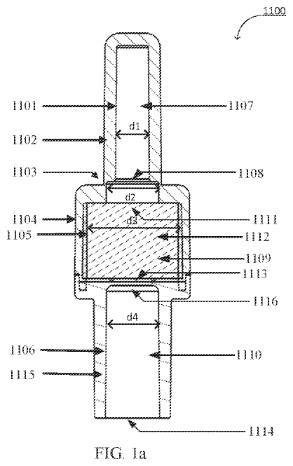

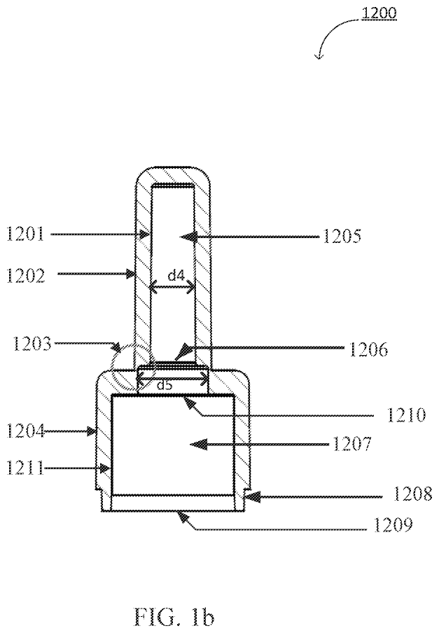

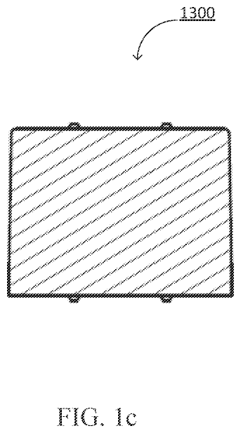

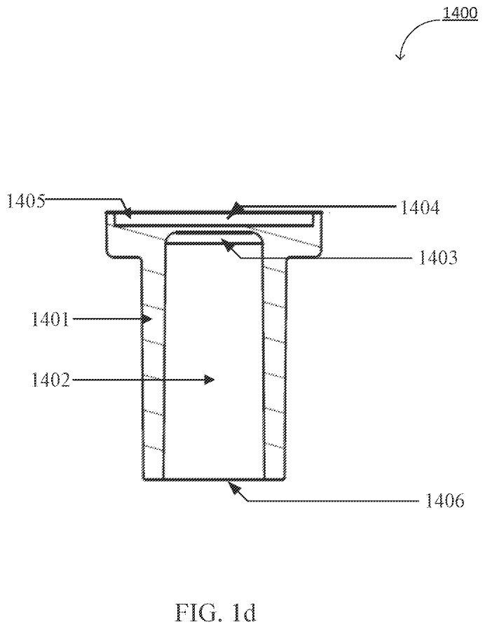

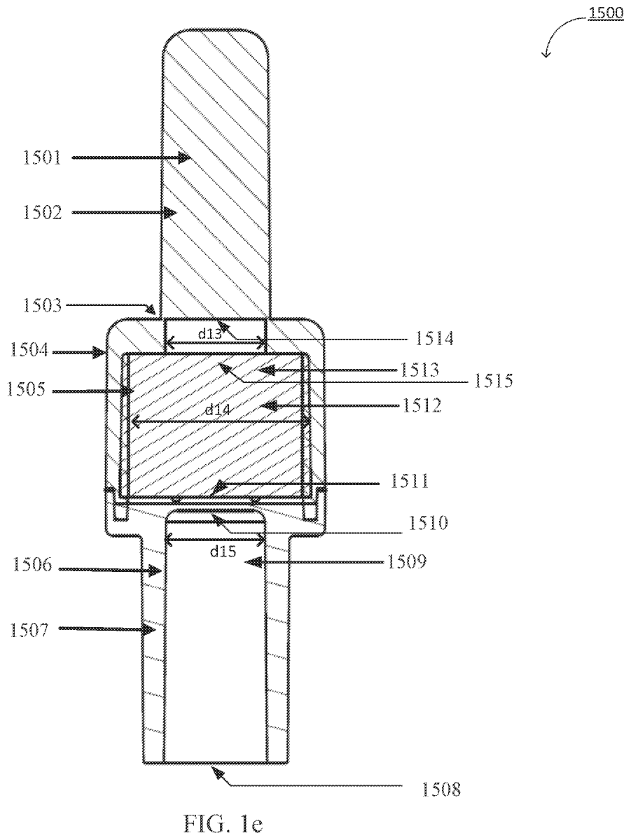

Referring now to FIG. 1a, a schematic depiction showing a cross-section of a design of the injection site 1100 according to certain embodiments of the present invention is depicted. As shown in FIG. 1a, the injection site 1100 for transferring a fluid from a pharmaceutical flexible container comprises a top part 1101, a center part 1104, a breakable zone 1103 and an insert part 1106.

As shown in FIG. 1a, the top part 1101 comprises a first enclosure 1102 enclosing either a solid body or hollow body with any shape as understood by the skilled in the art. For example, the first enclosure 1102 may enclose a hollow body for saving materials. In one embodiment, the first enclosure 1102 encloses a first tunnel 1107. The first tunnel 1107 can be any shape or size as understood by the skilled in the art. In one embodiment, the first tunnel has a cylinder shape. In one embodiment, the first tunnel 1107 has a diameter of d1.

The top part 1101 comprises a first opening 1108 with any shape or size to allow access to a septum to pierce the injection site with a needle. In one embodiment, the first opening 1108 has a gradually enlarging inner diameter with the first inner diameter d1 as the starting point. Thus, the first opening 1108 comprises a first end and a second end. In one embodiment, the first end of the first opening 1108 has a diameter size the same as the first inner diameter d1. The second end of the first opening 1108 has a second inner diameter d2. In one embodiment, d2 is greater than d1.

In one embodiment, the diameter of d2 is in the range of 0.0001-1000 millimeters (mm), 0.001-500 mm, 0.005-200 mm, 0.01-150 mm, 0.05-100 mm, 0.1-50 mm, 0.2-40 mm, 0.3-30 mm, 0.4-20 mm, 0.5-15 mm, 0.6-14 mm, 0.7-13 mm, 0.8-12 mm, 0.9-11 mm or 1-10 mm. Preferably, the diameter of d2 is in the range of 1-10 mm, more preferably, 2-9 mm, 3-8 mm, or 4-7 mm, most preferably, 4.5 mm.

As shown in FIG. 1a, the center part 1104 comprises a second opening 1111 connecting to the second end of the first opening 1108, and the second opening 1111 has a diameter size the same as that of the second inner diameter d2.

In one embodiment, a sterility barrier seals both the first opening 1108 and the second opening 1111. For example, as shown in FIG. 1a, the sterility barrier seals both the first opening 1108 and the second opening 1111. Even after the breakable zone 1103 breaks, the sterility barrier seals the second opening 1111 so that the septum 1112 is sealed within the first housing 1109.

The center part 1104 comprises a second enclosure 1105 enclosing a first housing 1109 having a third inner diameter d3 for holding a septum 1112.

In one embodiment, the third inner diameter d3 has a size smaller than, the same as or greater than that of the septum 1112.

In one preferred embodiment, the third inner diameter d3 is smaller than the diameter of the septum 1112 to keep the septum 1112 tight inside of the first housing 1109.

In one embodiment, the second enclosure 1105 is designed in its shape and material to form the first housing 1109 in such size and shape that the septum 1112 can be tightly held and sealed inside the walls of the second enclosure 1105. For example, in one embodiment, the first housing 1109 has the walls with the same size and shape as that of the septum 1112 so that the septum 1112 is tightly held and sealed inside the walls of the first housing 1109.

In one embodiment, the center part 1104 comprises a third opening 1113. In one embodiment, the third opening 1113 has the same diameter size as that of the third inner diameter d3.

As shown in FIG. 1a, the breakable zone 1103 is located between the top part 1101 and the center part 1104.

In one embodiment, the breakable zone 1103 comprises a wall thinner than that of the first enclosure 1102 and that of the second enclosure 1105. For example, the wall of the breakable zone 1103 is substantially thinner than that of the first enclosure 1102 and/or that of the second enclosure 1105. In one embodiment, the wall of the breakable zone 1103 is at least 30%, 40%, 50%, 60%, 70%, 80%, 90%, 100%, 150%, 200%, 250%, 300%, 350%, 400%, 450%, 500%, 550%, 600%, 650%, 700%, 750%, 800%, 850%, 900%, 950%, or 1000% thinner than that of the first enclosure 1102 and/or that of the second enclosure 1105. Preferably, the wall of the breakable zone 1103 is at least 100%, 150%, 200%, 250%, 300%, 350%, 400%, 450%, 500%, 550%, 600%, 650%, 700%, or 750% thinner than that of the first enclosure 1102 and that of the second enclosure 1105.

In one embodiment, the breakable zone 1103 (e.g., 0.2 mm) is about 500% smaller than that of the wall (e.g., 1 mm). Depending on the material, the breakable zone 1103 could be anywhere between about 0.01 mm and 10 mm, 0.02 mm and 9 mm, 0.03 mm and 8 mm, 0.04 mm and 7 mm, 0.045 and 6 mm, or 0.05 mm and about 5 mm, preferably 0.05 mm and 5 mm.

In one embodiment, the breakable zone 1103 is made of a material stiff enough to allow an easy breakage of the breakable top part 1101 (e.g., a breakable tamper-evident cap) and ductile enough to prevent the formation of particles after the breakage.

In one embodiment, the breakable zone 1103 is made of a leak-free material, thus preventing the septum 1112 from contamination by any liquid from the pharmaceutical flexible container. In one preferred embodiment, the surface of the septum 1112 does not require disinfection before its first use.

In another embodiment, the shape of the top part 1101 and the dimension of the breakable zone 1103 may be changed so that the breakable zone 1103 may be easily removed by hand.

In another embodiment, the breakable zone 1103 may be tamper-evident, allowing a user to check for product integrity before use. In one preferred embodiment, the breakable zone 1103 may not be replaced once it is removed.

In one embodiment, the first enclosure 1102, the second enclosure 1105 and the breakable zone 1103 are each made of the same material or a similar material.

For example, the first enclosure 1102, the second enclosure 1105 and the breakable zone 1103 are each made of a blend of polyethylene (PE), polypropylene (PP), or copolymers of ethylene and propylene with a polyolefin elastomer and/or an ethylene-vinyl Acetate (EVA). In one embodiment, the polyolefin elastomer comprises styrene-ethylene-butyl-ene-styrene (SEBS). In one embodiment, the polyolefin elastomer is styrene-ethylene-butylene-styrene (SEBS).

In one embodiment, the first enclosure 1102, the second enclosure 1105 and the breakable zone 1103 are each made of a blend of polyethylene (PE) with a polyolefin elastomer and/or an ethylene-vinyl Acetate (EVA).

In one embodiment, the first enclosure 1102, the second enclosure 1105 and the breakable zone 1103 are each made of a blend of polypropylene (PP) with a polyolefin elastomer and/or an ethylene-vinyl Acetate (EVA).

In one embodiment, the first enclosure 1102, the second enclosure 1105 and the breakable zone 1103 are each made of a blend of copolymers of ethylene and propylene with a polyolefin elastomer and/or an ethylene-vinyl Acetate (EVA).

In one embodiment, the first enclosure 1102, the second enclosure 1105 and the breakable zone 1103 are each made of a blend of polyethylene (PE) with a polyolefin elastomer and an ethylene-vinyl Acetate (EVA).

In one embodiment, the first enclosure 1102, the second enclosure 1105 and the breakable zone 1103 are each made of a blend of polypropylene (PP) with a polyolefin elastomer and an ethylene-vinyl Acetate (EVA).

In one embodiment, the first enclosure 1102, the second enclosure 1105 and the breakable zone 1103 are each made of a blend of copolymers of ethylene and propylene with a polyolefin elastomer and an ethylene-vinyl Acetate (EVA).

In one embodiment, the first enclosure 1102, the second enclosure 1105 and the breakable zone 1103 are all made of the same material.

In one preferred embodiment, the first enclosure 1102, the second enclosure 1105 and the breakable zone 1103 are all made of a blend of polypropylene (PP), Styrene-ethylene-butylene-styrene (SEBS) and/or ethylene-vinyl Acetate (EVA). More preferably, the first enclosure 1102, the second enclosure 1105 and the breakable zone 1103 are all made of a blend of polypropylene (PP), Styrene-ethylene-butylene-styrene (SEBS) and ethylene-vinyl Acetate (EVA).

In another embodiment, the first enclosure 1102, the second enclosure 1105 and the breakable zone 1103 are each made of a different blend of polypropylene (PP), Sty-rene-ethylene-butylene-styrene (SEBS) and/or ethylene-vinyl Acetate (EVA). For example, the first enclosure 1102, the second enclosure 1105 and the breakable zone 1103 are each made of a different blend of polypropylene (PP), Styrene-ethylene-butylene-styrene (SEBS) and ethylene-vinyl Acetate (EVA).

Referring back to FIG. 1a, the septum 1112 is a self-sealing septum. For example, the septum 1112 may seal small punctures (e.g., needle punctures) automatically itself without the usual process or procedure for sealing.

In one embodiment, the septum 1112 is made of an elastomeric material. For example, the septum 1112 is made of an elastomeric material selected from the group consisting of polyisoprene, silicone, natural rubber, polychloroprene, nitrile, carboxylated acrylonitrile butadiene rubber, styrene butadiene rubber, butadiene co-polymer, polyurethane, vinyl, and mixtures thereof.

In one embodiment, the septum 1112 is made of polyisoprene.

As shown in FIG. 1a, the insert part 1106 is attached to the center part 1104 from the bottom of the center part 1104.

As shown in FIG. 1a, the insert part 1106 comprises a third enclosure 1115 enclosing a second tunnel 1110. The second tunnel 1110 can have any shapes or sizes to allow a liquid to flow from a monobag or MCB to a needle piercing the related membrane (e.g., a membrane 1116).

In one embodiment, the third enclosure 1115 is made from the same material from that of the first enclosure 1102, the second enclosure 1105 and/or the breakable zone 1103.

In one embodiment, the third enclosure 1115 is made of a material different from that of the first enclosure 1102, the second enclosure 1105 and/or the breakable zone 1103.

For example, the third enclosure 1115 may be made of a blend of polyethylene (PE), polypropylene (PP), or copolymers of ethylene and propylene with a polyolefin elastomer and/or an ethylene-vinyl Acetate (EVA). In one embodiment, the polyolefin elastomer comprises styrene-ethylene-butylene-styrene (SEBS). In one embodiment, the polyolefin elastomer is styrene-ethylene-butylene-styrene (SEBS).

In one embodiment, the third enclosure 1115 may be made of a blend of polyethylene (PE) with a polyolefin elastomer and/or an ethylene-vinyl Acetate (EVA).

In one embodiment, the third enclosure 1115 may be made of a blend of polypropylene (PP) with a polyolefin elastomer and/or an ethylene-vinyl Acetate (EVA).

In one embodiment, the third enclosure 1115 may be made of a blend of copolymers of ethylene and propylene with a polyolefin elastomer and an ethylene-vinyl Acetate (EVA).

In one preferred embodiment, the third enclosure 1115 may be made of a blend of polypropylene (PP), Styrene-ethylene-butylene-styrene (SEBS) and/or ethylene-vinyl Acetate (EVA). More preferably, the third enclosure 1115 may be made of a blend of polypropylene (PP), Styrene-ethylene-butylene-styrene (SEBS) and ethylene-vinyl Acetate (EVA).

In one embodiment, the second tunnel 1110 has a fourth inner diameter d4. In one preferred embodiment, the fourth inner diameter d4 is smaller than that of the third inner diameter d3 of the septum 1112.

In one embodiment, the top side of the third enclosure 1115 comprises a membrane 1116. In one embodiment, a top surface of the membrane 1116 seals the third opening 1113 of the second enclosure 1105.

In one embodiment, the membrane 1116 is made of the same material as that of the inert part 1106. In one embodiment, the membrane 1116 is made of a material different from that of the septum 1112.

In one embodiment, the membrane 1116 is made of a blend of polyethylene (PE), polypropylene (PP), or copolymers of ethylene and propylene with a polyolefin elastomer and/or an ethylene-vinyl Acetate (EVA). In one embodiment, the polyolefin elastomer comprises styrene-ethylene-butyl-ene-styrene (SEBS). In one embodiment, the polyolefin elastomer is styrene-ethylene-butylene-styrene (SEBS).

In one embodiment, the membrane 1116 is molded together with other parts of the injection site 1100 such as the top part 1101, the center part 1104, the breakable zone 1103 and the insert part 1106. Thus, the membrane 1116 is made of the same material as that of the top part 1101, the center part 1104, the breakable zone 1103 and the insert part 1106.

In one embodiment, the membrane 1116 may prevent direct contact of the self-sealing septum 1112 with the solution (i.e., the liquid or the fluid). The membrane 1116 may also enhance the gas permeability properties, reducing the water loss of the liquid or the fluid, and protecting the solution (i.e., the liquid or the fluid) from oxygen transfer. Further, the membrane 1116 may also reduce the risk of having substances leaching from the septum 1112 that is usually made from polyisoprene rubber.

In one embodiment, the presence of the membrane 1116 prevents the substances from leaching by avoiding direct contact of the self-sealing septum 1112 with the solution.

Further, the membrane 1116 may be thin enough to allow for easy piercing.

In one embodiment, the second enclosure 1105 of the center part 1104 comprises a convex structure near the third opening 1113 and the convex structure fits in a concave structure on the top surface of the insert part 1106. FIG. 1b shows an exemplary convex structure 1208 near the third opening 1209 of a second enclosure 1204. FIG. 1d shows an exemplary concave structure 1405 on the top surface 1404 of the insert part 1400.

As shown in FIG. 1a, the insert part 1106 comprises a fourth opening 1114, through which a fluid is movable between the injection site 1100 and the pharmaceutical flexible container (e.g., monobags or MCBs).

In one embodiment, the top part 1101, the center part 1104, the breakable zone 1103 and the insert part 1106 are four parts of one single and integrated device. For example, the top part 1101, the center part 1104 and the insert part 1106 may be separately manufactured and later assembled into the single device of the injection site 1100.

In another embodiment, the top part 1101, the center part 1104 and the insert part 1106 may be separately manufactured or molded. In one embodiment, the top part 1101, the center part 1104 and the insert part 1106 may be assembled into the injection site 1100 and then be gamma-irradiated for sterilization before it can be used.

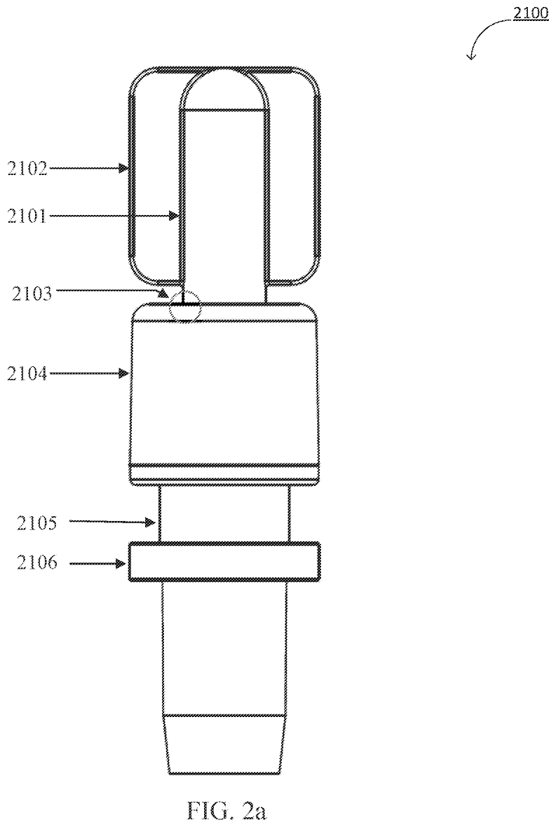

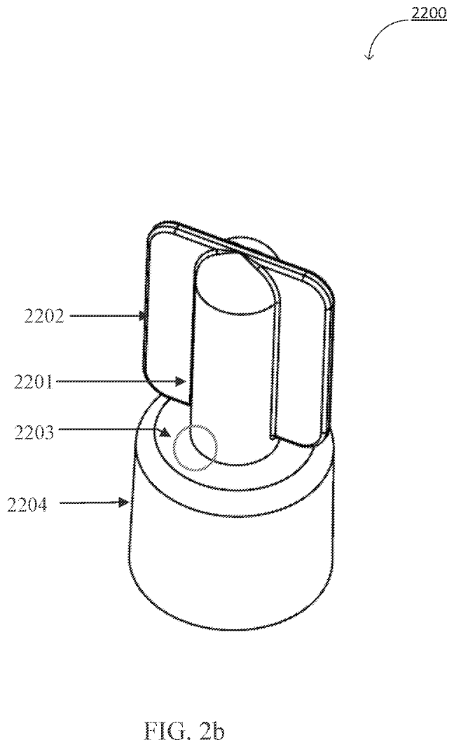

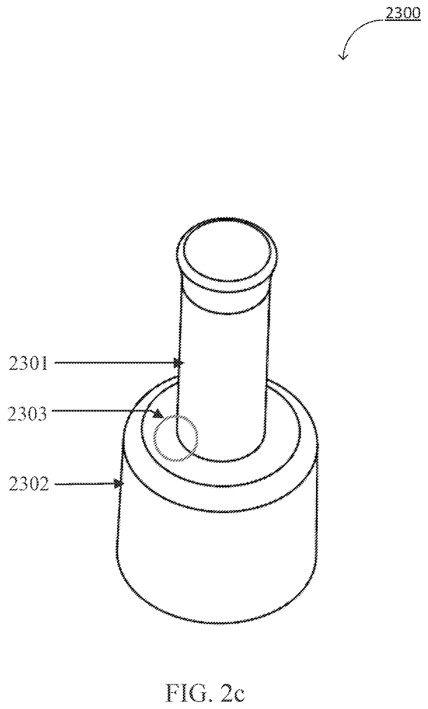

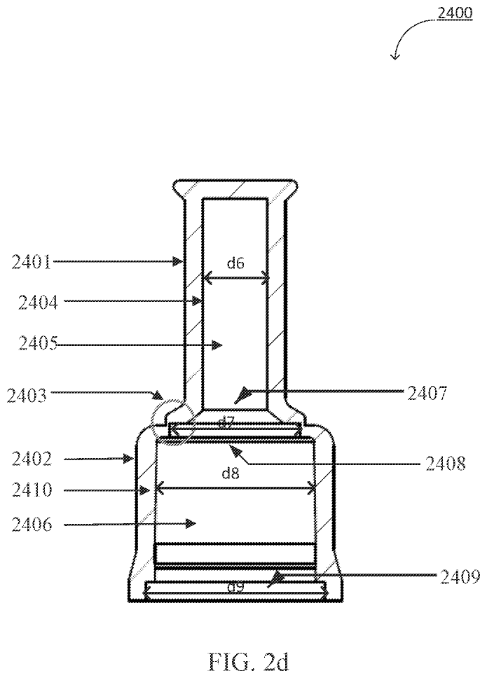

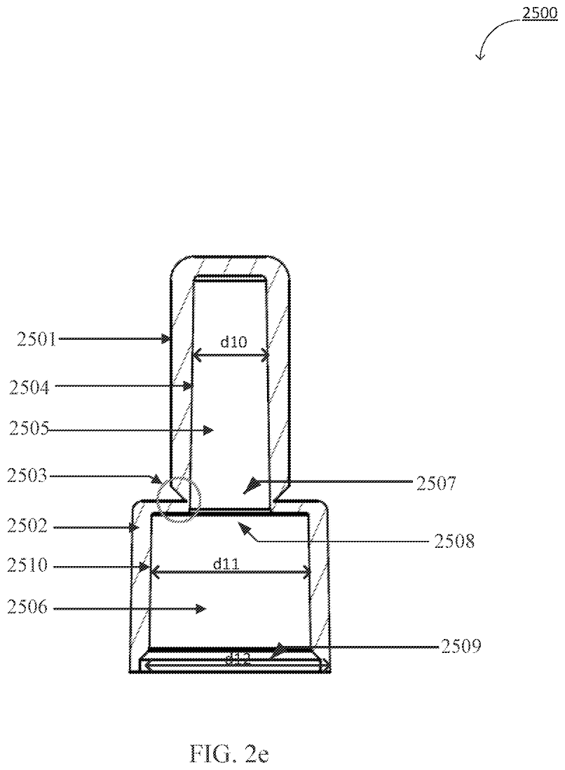

In one embodiment, the top part 1101 may comprise a fin attached to an outside surface of the first enclosure 1102. For example, FIG. 2a shows an exemplary fin 2102 to the outside surface of the first enclosure of the top part 2101.

In one embodiment, the insert part 1106 may comprise a flange attached to an outside surface of the third enclosure 1115. For example, FIG. 2a shows an exemplary flange 2106 to the outside surface of a third enclosure of an insert part 2105. In one embodiment, addition of a flange on the insert part may make automated insertion easier.

In another embodiment, the first enclosure 1102 of the top part 1101 may enclose a solid body. For example, FIG. 1e shows an exemplary injection site 1500 with a top part 1501 comprising a first enclosure 1502 enclosing a solid body. The only difference between the injection site 1100 of FIG. 1a and the injection site 1500 of FIG. 1e is that the first enclosure 1502 of FIG. 1e encloses a solid body while the first enclosure 1102 of FIG. 1a encloses a hollow body as discussed above.

As shown in FIG. 1e, the top part 1501 also comprises a first opening 1514 with a thirteen inner diameter and the thirteen inner diameter is the same as that of the second opening 1515 of the center part 1504. The center part 1504 also comprises a second enclosure 1505 enclosing a first housing 1512 having a fourteenth inner diameter d14 for holding a septum 1513. The center part 1504 also comprises a third opening 1511, which has the same diameter size as that of the fourteenth inner diameter d14. The injection site 1500 further comprises an insert part 1506 comprising a third enclosure 1507 enclosing a tunnel 1509 with a fifteenth inner diameter d15. The top side of the third enclosure 1507 comprises a membrane 1510 and a top surface of the membrane 1510 seals the third opening 1511 of the second enclosure 1505.

Referring now to FIG. 1b, a schematic depiction of a cross-section of part of the design of the injection site 1200 according to FIG. 1a of the present invention is shown.

As shown in FIG. 1b, the injection site 1200 comprises a top part 1201, a center part 1204, a breakable zone 1203 between the top part 1201 and the center part 1204.

The top part 1201 comprises a first enclosure 1202 enclosing either a solid body or hollow body with any shape as understood by the skilled in the art. For example, the first enclosure 1202 may enclose a hollow body for saving materials. In one embodiment, the first enclosure 1202 encloses a first tunnel 1205. As discussed herein, the first tunnel 1205 can be any shape as understood by the skilled in the art. In one embodiment, the first tunnel 1205 has a cylinder shape. In one embodiment, the first tunnel 1205 has a fourth inner diameter d4. The fourth inner diameter d4 is similar to the first inner diameter d1. Thus, d4 has thus been defined herein in this disclosure and understood by the skilled in the art.

The top part 1201 comprises a first opening 1206 having a gradually enlarging inner diameter with the fourth inner diameter d4 as the starting point. Thus, the first opening 1206 comprises a first end and a second end. In one embodiment, the first end of the first opening 1206 has a diameter size the same as that of the fourth inner diameter d4. The second end of the first opening 1206 has a fifth inner diameter d5. In one embodiment, d5 is greater than d4. The fifth inner diameter d5 is similar to the second inner diameter d2. Thus, d5 has thus been defined herein in this disclosure and understood by the skilled in the art.

As shown in FIG. 1b, the center part 1204 comprises a second opening 1210 connecting to the second end of the first opening 1206. In one embodiment, the second opening 1210 has a diameter size the same as that of the fifth inner diameter.

In one embodiment, a sterility barrier seals both the first opening 1206 and the second opening 1210. For example, as shown in FIG. 1b, the sterility barrier seals both the first opening 1206 and the second opening 1210. Even after the breakable zone 1203 breaks, the sterility barrier seals the second opening 1210 so that a septum (not shown) would be sealed within a first housing 1207.

The center part 1204 comprises a second enclosure 1211 enclosing a first housing 1207 having an inner diameter suitable for holding a septum (not shown).

As defined in this disclosure, the second enclosure 1211 is specifically designed in its shape and material to form the first housing 1207 with specific size and shape so that a septum can be tightly held and sealed inside the walls of the second enclosure 1211. For example, in one embodiment, the first housing 1207 has the walls with the same size and shape as that of a septum so that the septum is tightly held and sealed inside the walls of the first housing 1207.

The center part 1204 comprises a third opening 1209.

As shown in FIG. 1b, the breakable zone 1203 is located between the top part 1201 and the center part 1204.

The breakable zone 1203 has been defined in this disclosure. For example, the breakable zone 1203 comprises a wall which is thinner than that of the first enclosure 1202. In one embodiment, the wall of the breakable zone 1203 is substantially thinner than that of the first enclosure 1202. In one embodiment, the wall of the breakable zone 1203 is at least 30%, 40%, 50%, 60%, 70%, 80%, 90%, 100%, 150%, 200%, 250%, 300%, 350%, 400%, 450%, 500%, 550%, 600%, 650%, 700%, 750%, 800%, 850%, 900%, 950%, or 1000% thinner than that of the first enclosure 1202. Preferably, the wall of the breakable zone 1203 is at least 100%, 150%, 200%, 250%, 300%, 350%, 400%, 450%, 500%, 550%, 600%, 650%, 700%, or 750% thinner than that of the first enclosure 1202.

In one embodiment, the breakable zone 1203 (e.g., 0.2 mm) is about 500% smaller than that of the wall (e.g., 1 mm). Depending on the material, the breakable zone 1203 could be anywhere between about 0.01 mm and 10 mm, 0.02 mm and 9 mm, 0.03 mm and 8 mm, 0.04 mm and 7 mm, 0.045 and 6 mm, or 0.05 mm and about 5 mm, preferably 0.05 mm and 5 mm.

In one embodiment, the breakable zone 1203 is made of a material stiff enough to allow an easy breakage of the breakable tamper evident cap and ductile enough to prevent the formation of particles after the breakage.

In one embodiment, the breakable zone 1203 is made of a leak-free material, thus preventing a septum (now shown) from contamination by any liquid from the pharmaceutical flexible container. In one preferred embodiment, the surface of the septum does not require disinfection before its first use.

In another embodiment, the shape of the top part 1201 and the dimension of the breakable zone 1203 may be adjusted so that the breakable zone 1203 may be easily removed by hand.

In another embodiment, the breakable zone 1203 may be tamper-evident, allowing a user to check for product integrity before use. In one preferred embodiment, the breakable zone 1203 may not be replaced once it is removed.

In one embodiment, the center part 1204 comprises a convex structure 1208 near the third opening 1209 of a second enclosure 1204.

In one embodiment, the first enclosure 1202, the second enclosure 1211 and the breakable zone 1203 are each made of the same material or a similar material.

For example, the first enclosure 1202, the second enclosure 1211 and the breakable zone 1203 are each made of a blend of polyethylene (PE), polypropylene (PP), or copolymers of ethylene and propylene with a polyolefin elastomer and/or an ethylene-vinyl Acetate (EVA). In one embodiment, the polyolefin elastomer comprises styrene-ethylene-butyl-ene-styrene (SEBS). In one embodiment, the polyolefin elastomer is styrene-ethylene-butylene-styrene (SEBS).

In one embodiment, the first enclosure 1202, the second enclosure 1211 and the breakable zone 1203 are each made of a blend of polyethylene (PE) with a polyolefin elastomer and/or an ethylene-vinyl Acetate (EVA).

In one embodiment, the first enclosure 1202, the second enclosure 1211 and the breakable zone 1203 are each made of a blend of polypropylene (PP) with a polyolefin elastomer and/or an ethylene-vinyl Acetate (EVA).

In one embodiment, the first enclosure 1202, the second enclosure 1211 and the breakable zone 1203 are each made of a blend of copolymers of ethylene and propylene with a polyolefin elastomer and/or an ethylene-vinyl Acetate (EVA).

In one embodiment, the first enclosure 1202, the second enclosure 1211 and the breakable zone 1203 are each made of a blend of polyethylene (PE) with a polyolefin elastomer and an ethylene-vinyl Acetate (EVA).

In one embodiment, the first enclosure 1202, the second enclosure 1211 and the breakable zone 1203 are each made of a blend of polypropylene (PP) with a polyolefin elastomer and an ethylene-vinyl Acetate (EVA).

In one embodiment, the first enclosure 1202, the second enclosure 1211 and the breakable zone 1203 are each made of a blend of copolymers of ethylene and propylene with a polyolefin elastomer and an ethylene-vinyl Acetate (EVA).

In one embodiment, the first enclosure 1202, the second enclosure 1211 and the breakable zone 1203 are all made of the same material.

In one preferred embodiment, the first enclosure 1202, the second enclosure 1211 and the breakable zone 1203 are all made of a blend of polypropylene (PP), Styrene-ethylene-butylene-styrene (SEBS) and/or ethylene-vinyl Acetate (EVA). More preferably, the first enclosure 1202, the second enclosure 1211 and the breakable zone 1203 are all made of a blend of polypropylene (PP), Styrene-ethylene-butylene-styrene (SEBS) and ethylene-vinyl Acetate (EVA).

In another embodiment, the first enclosure 1202, the second enclosure 1211 and the breakable zone 1203 are each made of a different blend of polypropylene (PP), Sty-rene-ethylene-butylene-styrene (SEBS) and/or ethylene-vinyl Acetate (EVA). For example, the first enclosure 1202, the second enclosure 1211 and the breakable zone 1203 are each made of a different blend of polypropylene (PP), Styrene-ethylene-butylene-styrene (SEBS) and ethylene-vinyl Acetate (EVA).

Referring now to FIG. 1c, a schematic depiction of a cross-section of part of the design of the injection site according to FIG. 1a of the present invention is shown. Specifically, FIG. 1c shows a cross-section of a septum 1300.

In one embodiment, the septum 1300 is a self-sealing septum. For example, the septum 1300 may seal small punctures (e.g., needle punctures) automatically itself without the usual process or procedure for sealing.

In one embodiment, the septum 1300 is made of an elastomeric material. For example, the septum 1300 is made of an elastomeric material selected from the group consisting of polyisoprene, silicone, natural rubber, polychloroprene, nitrile, carboxylated acrylonitrile butadiene rubber, styrene butadiene rubber, butadiene co-polymer, polyurethane, vinyl, and mixtures thereof.

In one embodiment, the septum 1300 is made of polyisoprene.

FIG. 1d shows a schematic depiction of a cross-section of part of the design of the injection site according to FIG. 1a of the present invention. Specifically, FIG. 1d shows a cross-section of an insert part 1400.

As shown in FIG. 1d, the insert part 1400 comprises a third enclosure 1401 enclosing a second tunnel 1402.

In one embodiment, the top side of the third enclosure 1401 comprises a membrane 1403. In one embodiment, a top surface 1404 of the membrane 1403 is capable of sealing the third opening 1209 of the second enclosure 1211.

The membrane 1403 may be made of a material as defined in this disclosure or any other material understood by the skilled in the art.

For example, in one embodiment, the membrane 1403 is made of the same material as that of the corresponding inert part (e.g., 1400 of FIG. 1d). In one embodiment, the membrane 1403 is made of a material different from that of the corresponding septum (e.g., 1300 of FIG. 1c).

In one embodiment, the membrane 1403 is made of a blend of polyethylene (PE), polypropylene (PP), or copolymers of ethylene and propylene with a polyolefin elastomer and/or an ethylene-vinyl Acetate (EVA). In one embodiment, the polyolefin elastomer comprises styrene-ethylene-butyl-ene-styrene (SEBS). In one embodiment, the polyolefin elastomer is styrene-ethylene-butylene-styrene (SEBS).

In one embodiment, the membrane 1403 is molded together with other parts of the corresponding injection site (e.g., 1100 of FIG. 1a) such as the corresponding top part (e.g., 1101 of FIG. 1a), the corresponding center part (e.g., 1104 of FIG. 1a), the corresponding breakable zone (e.g., 1103 of FIG. 1a) and the corresponding insert part (e.g., 1400 of FIG. 1d). Thus, the membrane 1403 is made of the same material as that of the corresponding top part (e.g., 1101 of FIG. 1a), the corresponding center part (e.g., 1104 of FIG. 1a), the corresponding breakable zone (e.g., 1103 of FIG. 1a) and the corresponding insert part (e.g., 1400 of FIG. 1d).

The third enclosure 1401 may be made of a blend of polyethylene (PE), polypropylene (PP), or copolymers of eth-ylene and propylene with a polyolefin elastomer and/or an ethylene-vinyl Acetate (EVA). In one embodiment, the polyolefin elastomer comprises styrene-ethylene-butylene-sty-rene (SEBS). In one embodiment, the polyolefin elastomer is styrene-ethylene-butylene-styrene (SEBS).

In one embodiment, the third enclosure 1401 may be made of a blend of polyethylene (PE) with a polyolefin elastomer and/or an ethylene-vinyl Acetate (EVA).

In one embodiment, the third enclosure 1401 may be made of a blend of polypropylene (PP) with a polyolefin elastomer and/or an ethylene-vinyl Acetate (EVA).

In one embodiment, the third enclosure 1401 may be made of a blend of copolymers of ethylene and propylene with a polyolefin elastomer and an ethylene-vinyl Acetate (EVA).

In one preferred embodiment, the third enclosure 1401 may be made of a blend of polypropylene (PP), Styrene-ethylene-butylene-styrene (SEBS) and/or ethylene-vinyl Acetate (EVA). More preferably, the third enclosure 1401 may be made of a blend of polypropylene (PP), Styrene-ethylene-butylene-styrene (SEBS) and ethylene-vinyl Acetate (EVA).

FIG. 1d shows an exemplary concave structure 1405 on the top surface 1404 of the insert part 1400.

As shown in FIG. 1d, the insert part 1400 comprises a fourth opening 1406, through which a fluid is movable between the present injection site and a pharmaceutical flexible container (e.g., monobags or MCBs).

Referring now to FIGS. 2a and 2b, schematic depic-tions of designs of the injection site 2100/2200 according to certain embodiments of the present invention are shown.

As shown in FIG. 2a, the injection site 2100 comprises a top part 2101 comprising a fin 2102, a center part 2104 holding a septum (not shown), a breakable zone 2103 between the top part 2101 and the center part 2104, and an insert part 2105 comprising a flange 2106.

As shown in FIG. 2b, the injection site 2200 comprises a top part 2201 comprising a fin 2202, a center part 2204 holding a septum (not shown), a breakable zone 2203 between the top part 2201 and the center part 2204.

The details of the top part 2101/2201, the center part 2104/2204, the breakable zone 2103/2203 and the insert part 2105 have been discussed in the disclosure.

In one embodiment, addition of the flange 2106 on the insert part 2105 may make automated insertion of the present injection site easier.

In one embodiment, addition of the fin 2102/2202 on the top part 2101/2201 may ease handling of the breakable part (e.g., the top part 2101/2201).

Referring now to FIG. 2c, a schematic depiction of a design of part of the injection site 2300 according to certain embodiments of the present invention is shown.

As shown in FIG. 2c, the injection site 2300 comprises a top part 2301, a center part 2302 holding a septum (not shown), a breakable zone 2303 between the top part 2301 and the center part 2302.

The details of the top part 2301, the center part 2302, and the breakable zone 2303 have been discussed in the disclosure.

Referring now to FIG. 2d, a schematic depiction of a cross-section of part of a design of the injection site 2400 according to certain embodiments of the present invention is shown.

As shown in FIG. 2d, the injection site 2400 comprises a top part 2401, a center part 2402 to hold a septum (not shown), a breakable zone 2403 between the top part 2401 and the center part 2402.

The details of the top part 2401, the center part 2402, and the breakable zone 2403 have been discussed in the disclosure.

For example, the top part 2401 comprises a first enclosure 2404 enclosing either a solid body or hollow body with any shape as understood by the skilled in the art. For example, the first enclosure 2404 may enclose a hollow body for saving materials. In one embodiment, the first enclosure 2404 encloses a first tunnel 2405. As discussed herein, the first tunnel 2405 can be any shape as understood by the skilled in the art. In one embodiment, the first tunnel 2405 has a cylinder shape. In one embodiment, the first tunnel 2405 has a sixth inner diameter d6. The sixth inner diameter d6 is similar to the first inner diameter d1. Thus, parameters of d6 have thus been defined herein in this disclosure and understood by the skilled in the art.

The top part 2401 comprises a first opening 2407 with various shapes (e.g., circle, square or other shapes). In one embodiment, first opening 2407 has a gradually enlarging inner diameter with the sixth inner diameter d6 as the starting point. Thus, the first opening 2407 comprises a first end and a second end. In one embodiment, the first end of the first opening 2407 has a diameter size the same as that of the sixth inner diameter d6. The second end of the first opening 2407 has a seventh inner diameter d7. In one embodiment, d7 is greater than d6. The seventh inner diameter d7 is similar to the second inner diameter d2. Thus, d7 has thus been defined herein in this disclosure and understood by the skilled in the art.

As shown in FIG. 2d, the center part 2402 comprises a second opening 2408 connecting to the second end of the first opening 2407, and the second opening 2408 has a diameter size the same as that of the seventh inner diameter d7.

In one embodiment, a sterility barrier (not shown) seals both the first opening 2407 and the second opening 2408. For example, even after the breakable zone 2403 breaks, the sterility barrier seals the second opening 2408 so that a septum (not shown) would be sealed within a first housing 2406.

The center part 2402 comprises a second enclosure 2410 enclosing a first housing 2406 having an eighth inner diameter d8 suitable for holding a septum (not shown).

As defined in this disclosure, the second enclosure 2410 is specifically designed in its shape and material to form the first housing 2406 with specific size and shape so that a septum can be tightly held and sealed inside the walls of the second enclosure 2410 (i.e., the first housing 2406). For example, in one embodiment, the first housing 2406 has the walls with the same size and shape as that of a septum so that the septum is tightly held and sealed inside the walls of the first housing 2406.

The center part 2402 comprises a third opening 2409.

As shown in FIG. 2d, the third opening 2409 has a gradually enlarging inner diameter with the eighth inner diameter d8 as the starting point. Thus, the third opening 2409 comprises a first end and a second end. In one embodiment, the first end of the third opening 2409 has a diameter size the same as that the eighth inner diameter d8. The second end of the third opening 2409 has a ninth inner diameter d9. In one embodiment, d9 is greater than d8.

As shown in FIG. 2d, the breakable zone 2403 is located between the top part 2401 and the center part 2402.

The breakable zone 2403 has been defined throughout this disclosure. For example, the breakable zone 2403 comprises a wall which is thinner than that of the first enclosure 2404 and/or that of the second enclosure 2410. In one embodiment, the wall of the breakable zone 2403 is substantially thinner than that of the first enclosure 2404 and/or that of the second enclosure 2410. In one embodiment, the wall of the breakable zone 2403 is at least 30%, 40%, 50%, 60%, 70%, 80%, 90%, 100%, 150%, 200%, 250%, 300%, 350%, 400%, 450%, 500%, 550%, 600%, 650%, 700%, 750%, 800%, 850%, 900%, 950%, or 1000% thinner than that of the first enclosure 2404. Preferably, the wall of the breakable zone 2403 is at least 100%, 150%, 200%, 250%, 300%, 350%, 400%, 450%, 500%, 550%, 600%, 650%, 700%, or 750% thinner than that of the first enclosure 2404 and/or that of the second enclosure 2410.

In one embodiment, the breakable zone 2403 (e.g., 0.2 mm) is about 500% smaller than that of the wall (e.g., 1 mm) of the first enclosure 2404 and/or that of the second enclosure 2410. Depending on the material, the breakable zone 2403 could be anywhere between about 0.01 mm and 10 mm, 0.02 mm and 9 mm, 0.03 mm and 8 mm, 0.04 mm and 7 mm, 0.045 and 6 mm, or 0.05 mm and about 5 mm, preferably 0.05 mm and 5 mm.

In one embodiment, the thinner wall of the breakable zone 2403 may be realized by removing part of the wall on the external surface and/or expanding the corresponding internal space (i.e., increasing d7 to remove part of the wall on the internal surface).

FIG. 2d provides an example of both removing part of the wall on the external surface and expanding the corresponding internal space (i.e., increasing d7 to remove part of the wall on the internal surface) to make a thinner wall of the breakable zone 2403.

In one embodiment, the breakable zone 2403 is made of a material stiff enough to allow an easy breakage of the breakable tamper evident cap and ductile enough to prevent the formation of particles after the breakage.

In one embodiment, the breakable zone 2403 is made of a leak-free material, thus preventing a septum (now shown) from contamination by any liquid from the pharmaceutical flexible container. In one preferred embodiment, the surface of the septum does not require disinfection before its first use.

In another embodiment, the shape of the top part 2401 and the dimension of the breakable zone 2403 may be adjusted so that the top part 2401 may be easily removed by hand after the breakage of the breakable zone 2403.

In another embodiment, the breakable zone 2403 may be tamper-evident, allowing a user to check for product integrity before use. In one preferred embodiment, the breakable zone 2403 may not be replaced once it is removed.

In one embodiment, the first enclosure 2404, the second enclosure 2410 and the breakable zone 2403 are each made of the same material or a similar material as defined throughout this disclosure.

Referring now to FIG. 2e, a schematic depiction of a cross-section of part of a design of the injection site 2500 according to certain embodiments of the present invention is shown.

As shown in FIG. 2e, the injection site 2500 comprises a top part 2501, a center part 2502 for holding a septum (not shown), a breakable zone 2503 between the top part 2501 and the center part 2502.

The top part 2501 comprises a first enclosure 2504 enclosing either a solid body or hollow body with any shape as understood by the skilled in the art. For example, the first enclosure 2504 may enclose a hollow body for saving materials. In one embodiment, the first enclosure 2504 encloses a first tunnel 2505. As discussed herein, the first tunnel 2505 can be any shape as understood by the skilled in the art. In one embodiment, the first tunnel 2505 has a cylinder shape. In one embodiment, the first tunnel 2505 has a tenth inner diameter d10. The tenth inner diameter d10 is similar to the first inner diameter d1. Thus, parameters of d10 have thus been defined herein in this disclosure and understood by the skilled in the art.

The top part 2501 comprises a first opening 2507 with a diameter size the same as that of the tenth inner diameter d10.

As shown in FIG. 2e, the center part 2502 comprises a second opening 2508 connecting to the first opening 2507, and the second opening 2508 has a diameter size the same as that of the tenth inner diameter d10.

The center part 2502 comprises a second enclosure 2510 enclosing a first housing 2506 having an eleventh inner diameter d11 suitable for holding a septum (not shown).

The center part 2502 comprises a third opening 2509.

As shown in FIG. 2e, the third opening 2509 has a gradually enlarging inner diameter with the eleventh inner diameter d11 as the starting point. Thus, the third opening 2509 comprises a first end and a second end. In one embodiment, the first end of the third opening 2509 has a diameter size the same as that the eleventh inner diameter d11. The second end of the third opening 2509 has a twelfth inner diameter d12. In one embodiment, d12 is greater than d11.

As shown in FIG. 2e, the breakable zone 2503 is located between the top part 2501 and the center part 2502.

The breakable zone 2503 has been defined throughout this disclosure. For example, the thinner wall of the breakable zone 2503 may be realized by removing part of the wall on the external surface and/or expanding the corresponding internal space (i.e., removing part of the wall on the internal surface).

FIG. 2e provides an example of removing part of the wall on the external surface to make a thinner wall of the breakable zone 2503.

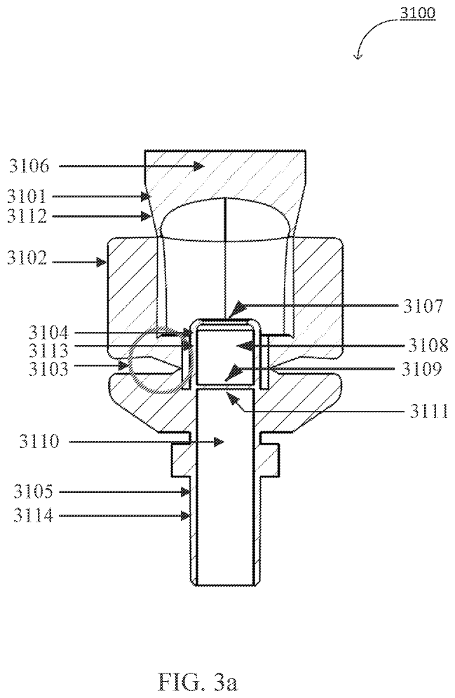

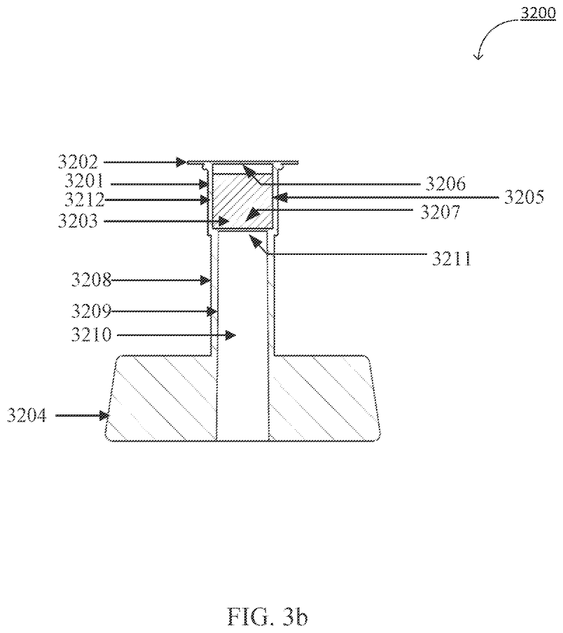

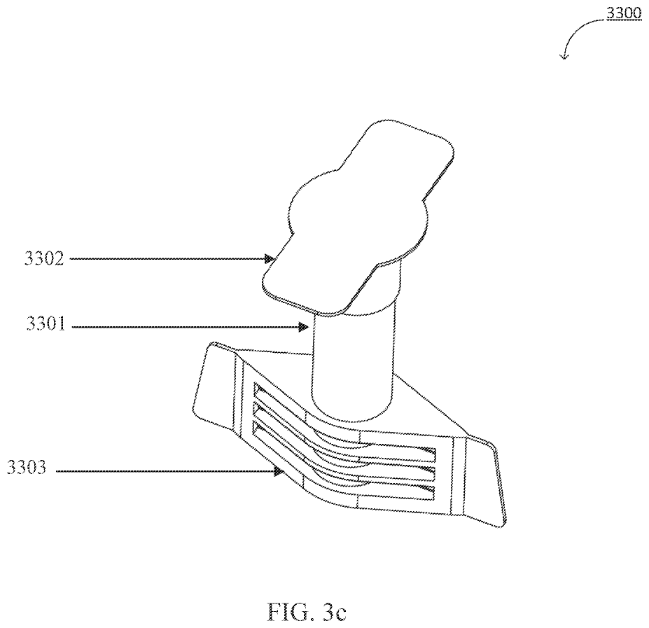

Referring now to FIG. 3a, a schematic depiction of a cross-section of a design of the injection site 3100 according to certain embodiments of the present invention is shown.

As shown in FIG. 3a, the injection site 3100 comprises a top part 3101 comprising a fin 3102, a center part 3104 to hold a septum (not shown), an insert part 3105, and a breakable zone 3103 between the top part 3101 and the insert part 3105.

The top part 3101 comprises a first enclosure 3112 enclosing either a solid body or hollow body with any shape as understood by the skilled in the art. For example, the first enclosure 3112 may enclose a hollow body for saving materials. In one embodiment, the first enclosure 3112 encloses a first tunnel 3106 and a first opening 3107 at the bottom of the first enclosure 3112.

In one embodiment, the top part 3101 comprises a fin 3102 attached to an outside surface of the first enclosure 3112.

As shown in FIG. 3a, the center part 3104 is located inside the first tunnel 3106 near the bottom of the first enclosure 3112.

The center part 3104 comprises a second enclosure 3113 enclosing a first housing 3108 for holding a septum (not shown).

In one embodiment, a sterility barrier (not shown) seals a top surface of the first housing 3108. For example, even after the removal of the top part 3101 after breakage of the breakable zone 3103, the sterility barrier seals the top surface of the first housing 3108 so that a septum (not shown) would be sealed within the first housing 3108.

The center part 3104 further comprises a membrane 3109 at the bottom of the second enclosure 3113.

The membrane 3109 has been discussed and defined throughout this disclosure.

As shown in FIG. 3a, the insert part 3105 comprises a third enclosure 3114 enclosing a second tunnel 3110. The insert part 3105 comprises a second opening 3111 at the top of the second tunnel 3110, and a bottom surface of the membrane 3109 seals the second opening 3111 of the third enclosure 3114.

As shown in FIG. 3a, the breakable zone 3103 is located between the top part 3101 and the insert part 3105.

In one embodiment, the breakable zone 3103 and the top part 3101 form a twist-off breakable part to protect the surface of a septum (not shown). In another embodiment, the breakable zone 3103 has been well defined in this disclosure.

Referring now to FIG. 3b, a schematic depiction of a cross-section of another design of the injection site 3200 according to certain embodiments of the present invention is shown.

As shown in FIG. 3b, the injection site 3200 comprises a top part 3201 holding a septum 3203, and a lid 3202 covering the septum 3203, and an insert part 3208 including a widened and flattened base 3204 to be sealed directly to a film.

In one embodiment, the top part 3201 comprises a first enclosure 3212 enclosing a first housing 3205 for holding the septum 3203. As detailed in this disclosure, the septum 3203 is a self-sealing septum. For example, the septum 3203 is made of an elastomeric material selected from the group consisting of polyisoprene, silicone, natural rubber, polychloroprene, nitrile, carboxylated acrylonitrile butadiene rubber, styrene butadiene rubber, butadiene co-polymer, polyurethane, vinyl, and mixtures thereof. In one preferred embodiment, the septum 3203 is made of polyisoprene.

In one embodiment, the first enclosure 3212 is designed in its shape and material to form the first housing 3205 in such size and shape that the septum 3203 can be tightly held and sealed inside the walls of the first enclosure 3212. For example, in one embodiment, the first housing 3205 has the walls with the same size and shape as that of the septum 3203 so that the septum 3203 is tightly held and sealed inside the walls of the first housing 3205.

As shown in FIG. 3b, the first housing 3205 comprises a first opening 3206 at the top of the first housing 3205.

The lid 3202 covers and seals the first opening 3206 of the first housing 3205. In one embodiment, the lid 3202 may be assembled on the top of the first housing 3205 by heating or gluing or any other methods understood by the skilled in the art.

In one embodiment, a sterility barrier (not shown) seals both the first opening 3206. For example, even after the removal of the lid 3202, the sterility barrier seals the first opening 3206 so that a septum (not shown) would be sealed within the first housing 3205.

As shown in FIG. 3b, the top part 3201 comprises a membrane 3207 at the bottom of the first housing 3205. The membrane 3207 seals the septum 3203 inside the first housing 3205 so that the septum 3203 would not be in contact with any liquid from a first tunnel of the insert part 3208 below the top part 3201.

The details of the membrane 3207 have been discussed throughout this disclosure.

The insert part 3208 comprises a second enclosure 3209 enclosing a first tunnel 3210. The insert part 3208 further comprises a second opening 3211 at the top of the first tunnel 3210. In one embodiment, a bottom surface of the membrane 3207 seals the second opening of the insert part 3208.

In one embodiment, the septum 3203 is a self-sealing septum. For example, the septum 3203 is made of an elastomeric material selected from the group consisting of polyisoprene, silicone, natural rubber, polychloroprene, nitrile, carboxylated acrylonitrile butadiene rubber, styrene butadiene rubber, butadiene co-polymer, polyurethane, vinyl, and mixtures thereof. In one preferred embodiment, the septum 3203 is made of polyisoprene.

In one embodiment, the top part 3201, the lid 3202 and the insert part 3208 are three parts of one single and integrated device. For example, the top part 3201, the lid 3202 and the insert part 3208 may be separately manufactured and later molded into the single device of the medical device 3200.

In another embodiment, the top part 3201, the lid 3202 and the insert part 3208 may be separately manufactured or molded. In one embodiment, the top part 3201, the center part 3202 and the insert part 3208 may be assembled into the injection site 3200 and then be gamma-irradiated for sterilization before it can be used.

In one embodiment, the insert part 3208 includes a widened and flattened base 3204 to be sealed directly to a film.

For example, FIG. 3c shows a medical device 3300 comprises a top part 3301 holding a septum (not shown), and a lid 3302 covering the septum, and an insert part 3303 including a widened and flattened base 3204 to be sealed directly to a film. In one embodiment, the present medical device can be used on an access port system that combines both administration and injection sites.

In another aspect, the present invention relates methods of manufacturing the present medical devices/injection sites as discussed in this disclosure for transferring a fluid from a pharmaceutical flexible container.

The injection site 1100 is used below as an example of manufacturing. Other medical devices/injection sites of the present invention can be manufactured similarly.

In one embodiment, a method of manufacturing the present medical devices/injection sites such as the injection site 1100 may comprise the steps of:
1. manufacturing the individual parts of the injection site 1100 comprising the top part 1101, the center part 1104, the septum 1112, the center part 1104, and the insert part 1106;
2. assembling the top part 1101 and the center part 1104 into the part 1200 to form the breakable zone 1103 between the top part 1101 and the center part 1104;
3. inserting the septum 1112 into the first housing 1112 of the center part 1104; and
4. assembling the insert part into the part 1200 to form the injection site 1100.

In one embodiment, the parts are assembled or inserted by a method selected from the group consisting an ultrasonic sealing, vibration welding, spin welding, hot plate welding, laser welding, gluing, screwing, clipping, heat sealing and combinations thereof.

Alternatively, the parts may be assembled or inserted by another method understood by the skilled in the art. In one embodiment, the parts are assembled or inserted by a spin welding.

In one embodiment, the top part 1101 and the center part 1104 may be manufactured as a single part comprising the breakable zone 1103 between the top part 1101 and the center part 1104.

As disclosed above, the top part 1101, the breakable zone 1103, the center part 1104 and the insert part 1106 are each made of a blend of polyethylene (PE), polypropylene (PP), or copolymers of ethylene and propylene with a polyolefin elastomer and/or an ethylene-vinyl Acetate (EVA). In one embodiment, the polyolefin elastomer comprises sty-rene-ethylene-butylene-styrene (SEBS). In one embodiment, the polyolefin elastomer is styrene-ethylene-butylene-sty-rene (SEBS).

In one embodiment, the top part 1101, the breakable zone 1103, the center part 1104 and the insert part 1106 are each made of a blend of polyethylene (PE) with a polyolefin elastomer and/or an ethylene-vinyl Acetate (EVA).

In one embodiment, the top part 1101, the breakable zone 1103, the center part 1104 and the insert part 1106 are each made of a blend of polypropylene (PP) with a polyolefin elastomer and/or an ethylene-vinyl Acetate (EVA).

In one embodiment, the top part 1101, the breakable zone 1103, the center part 1104 and the insert part 1106 are each made of a blend of copolymers of ethylene and pro-pylene with a polyolefin elastomer and/or an ethylene-vinyl Acetate (EVA).

In one embodiment, the top part 1101, the breakable zone 1103, the center part 1104 and the insert part 1106 are each made of a blend of polyethylene (PE) with a polyolefin elastomer and an ethylene-vinyl Acetate (EVA).

In one embodiment, the top part 1101, the breakable zone 1103, the center part 1104 and the insert part 1106 are each made of a blend of polypropylene (PP) with a polyolefin elastomer and an ethylene-vinyl Acetate (EVA).

In one embodiment, the top part 1101, the breakable zone 1103, the center part 1104 and the insert part 1106 are each made of a blend of copolymers of ethylene and pro-pylene with a polyolefin elastomer and an ethylene-vinyl Acetate (EVA).

In one embodiment, the top part 1101, the breakable zone 1103, the center part 1104 and the insert part 1106 are all made of the same material.

In one preferred embodiment, the top part 1101, the breakable zone 1103, the center part 1104 and the insert part 1106 are all made of a blend of polypropylene (PP), Styrene-ethylene-butylene-styrene (SEBS) and/or ethylene-vinyl Acetate (EVA). More preferably, the top part 1101, the breakable zone 1103, the center part 1104 and the insert part 1106 are all made of a blend of polypropylene (PP), Styrene-ethylene-butylene-styrene (SEBS) and ethylene-vinyl Acetate (EVA).

In another embodiment, the top part 1101, the breakable zone 1103, the center part 1104 and the insert part 1106 are each made of a different blend of polypropylene (PP), Styrene-ethylene-butylene-styrene (SEBS) and/or eth-ylene-vinyl Acetate (EVA). For example, the top part 1101, the breakable zone 1103, the center part 1104 and the insert part 1106 are each made of a different blend of polypropylene (PP), Styrene-ethylene-butylene-styrene (SEBS) and ethylene-vinyl Acetate (EVA).

In one embodiment, the material of the top part 1101 and the center part 1104 shall be stiff enough to allow an easy breakage of the breakable tamper evident cap, as well as ductile enough to prevent the formation of particles.

Furthermore, the inner diameter of the first housing 1109 of the center part 1104 shall also be tight enough to guarantee enough compression on the septum 1112.

In one embodiment, the material of the insert part 1106 shall be soft enough to allow an easy and particle generation-free piercing with needles of various types and gauges.

In one embodiment, the materials of the parts are chosen so that they are ductile enough to prevent the formation of particles when tearing a break-zone, as well as when piercing with needles of various types and gauges.

In another aspect, the present invention relates to a method for transferring a fluid from a pharmaceutical flexible container by using the present medical device/injection site.

In one embodiment, the method comprises the steps of:
connecting the medical device/injection site with a pharmaceutical flexible container such as a MCB;
breaking the top part of the medical device/injection site;
piercing a needle of a syringe through the septum; and
transferring the fluid from the pharmaceutical flexible container.

In one embodiment, the insert part 1106 of the injection site 1100 is connected to a port tube of the pharmaceutical flexible container such as a monobag or a MCB.

In one embodiment, the top part 1101 of the injection site 1100 is twisted off by the breakage of the breakable zone 1103.

In one embodiment, the needle of the syringe is piercing from the first opening 1108 through the septum 1112 and the second tunnel 1110. Thus, the fluid in the pharmaceutical flexible container/MCB may be transferred from the pharmaceutical flexible container/MCB to the syringe.

The present medical devices/injections sites may have the following general advantages:
1. A tight fit between the top part 1101 and the septum 1112 is such that sterility barrier is maintained to prevent contamination of the membrane surface once the protection is removed, and to prevent microbiological ingress after perforation of the membrane 1116.
2. The top part 1101 and the insert part 1106 assembled by an ultrasonic seal may be leak-free.
3. After removal of the protection (e.g., removal of the breakable zone or lid), the diameter of the external surface of the septum 1112 has been chosen to help to guide a needle during insertion in order to avoid piercing through the walls of the injection site 1100.
4. The injection site 1100 may be compatible with a commercially available cap such as the Viaflo additive cap, hence allowing a user (e.g., a nurse) to prevent any further additions to the MCBs should he/she wants to.
5. The injection site 1100 may be compatible with insulin needles. In one embodiment, the distance between the membrane 1116 and the top of the injection site 1100 after removal of the protection from the breakable zone 1103 is smaller than 9.5 mm.
6. The parts are designed to be inserted automatically without damaging the parts.
7. The insert part 1106 is designed to allow for a leak-free connection with a port-tube of MCBs, by means of a tight fit.
8. The breakable zone 1103 acts as a tamper-evident part, allowing a user to check for product integrity before use.
9. The shape and the materials of the parts may be chosen to guarantee the sterility of the injection site 1100 by making the whole assembly capable of withstanding gamma sterilization.
10. The protection of the breakable zone or lid al-lows to guarantee the sterility of the surface of the septum even though it is sterilized without an over-pouch.

If not defined otherwise herein, all terms used in the context of the present invention are to be interpreted according to the understanding of a person skilled in the art.

It should be understood that various changes and modifications to the examples described here will be appar-ent to those skilled in the art. Such changes and modifications can be made without departing from the spirit and scope of the present subject matter and without diminishing its intended advantages. It is therefore intended that such changes and modifications be covered by the appended claims.

1. A medical device for transferring a fluid from a pharmaceutical flexible container, the medical device comprising:
a top part, the top part comprising:
a first enclosure enclosing a solid body or a hollow body;
a center part, the center part comprising:
a second opening connecting to the first opening, and the second opening having the second inner diameter;
a second enclosure enclosing a first housing having a third inner diameter for holding a septum;
a third opening having the third inner diameter;
a breakable zone between the top part and the center part; and
an insert part, the insert part comprising:
a third enclosure enclosing a second tunnel; and
the top side of the third enclosure comprising a membrane, wherein a top surface of the membrane seals the third opening of the second enclosure.

2. The medical device of claim 1, wherein the top part comprises:
the first enclosure enclosing a first tunnel having a first inner diameter; and
a first opening having a gradually enlarging inner diameter from the first inner diameter at a first end of the first opening to a second inner diameter at a second end of the first opening.

3. The medical device of claim 1, wherein the top part comprises:
the first enclosure enclosing the solid body; and
a first opening having a first inner diameter,
wherein the first inner diameter is the same as that of the second inner diameter.

4. The medical device of claim 1, wherein the first enclosure, the second enclosure and the breakable zone are all made of the same material.

5. The medical device of claim 4, wherein the first enclosure, the second enclosure and the breakable zone are all made of blends of polyethylene (PE), polypropylene (PP), copolymers of ethylene and propylene and mixture with polyolefin elastomers and/or ethylene-vinyl acetate (EVA)

6. The medical device of claim 4, wherein the first enclosure, the second enclosure and the breakable zone are all made of a blend of polypropylene (PP), Styrene-eth-ylene-butylene-styrene (SEBS) and ethylene-vinyl Acetate (EVA).

7. The medical device of claim 1, wherein the septum is a self-sealing septum.

8. The medical device of claim 7, wherein the septum is made of an elastomeric material selected from the group consisting of polyisoprene, silicone, natural rubber, polychloroprene, nitrile, carboxylated acrylonitrile butadiene rubber, styrene butadiene rubber, butadiene co-polymer, polyurethane, vinyl, and mixtures thereof.

9. The medical device of claim 7, wherein the septum is made of polyisoprene.

10. The medical device of claim 1, wherein the second enclosure of the center part comprises a convex structure near the third opening and the convex structure fits in a concave structure on the top surface of the insert part.

11. The medical device of claim 1, wherein the third inner diameter is greater than the second inner diameter.

12. The medical device of claim 1, wherein the breakable zone is made of a material stiff enough to allow an easy breakage of the breakable tamper evident cap and ductile enough to prevent the formation of particles after the breakage.

13. The medical device of claim 1, wherein the top part, the center part and the insert part are molded into a single device.

14. The medical device of claim 1, wherein the top part, the center part and the insert part are separately molded and assembled into a single device.

15. The medical device of claim 1, wherein the top part comprises a fin attached to an outside surface of the first enclosure.

16. The medical device of claim 1, wherein the insert part comprises a flange attached to an outside surface of the third enclosure.

17. An injection site, and the injection site comprising:
a top part, the top part comprising:
a first enclosure enclosing a first tunnel;
a first opening at the bottom of the first enclosure;
a center part located inside the first tunnel near the bottom of the first enclosure, the center part comprising:
a second enclosure enclosing a first housing for holding a septum; and
a membrane at the bottom of the second enclosure;
an insert part, the insert part comprising:
a third enclosure enclosing a second tunnel; and
a second opening at the top of the second tunnel, and a bottom surface of the membrane seals the second opening of the third enclosure; and
a breakable zone between the top part and the insert part.

18. The injection site of claim 17, wherein the first enclosure, the second enclosure and the breakable zone are all made of the same material.

19. The injection site of claim 17, wherein the first enclosure, the second enclosure and the breakable zone are all made of blends of polyethylene (PE), polypropylene (PP), copolymers of ethylene and propylene and mixture with polyolefin elastomers and/or ethylene-vinyl acetate (EVA)

20. The injection site of claim 17, wherein the first enclosure, the second enclosure and the breakable zone are all made of a blend of polypropylene (PP), Styrene-eth-ylene-butylene-styrene (SEBS) and ethylene-vinyl Acetate (EVA).

21. The injection site of claim 17, wherein the septum is a self-sealing septum.

22. The injection site of claim 21, wherein the septum is made of an elastomeric material selected from the group consisting of polyisoprene, silicone, natural rubber, polychloroprene, nitrile, carboxylated acrylonitrile butadiene rubber, styrene butadiene rubber, butadiene co-polymer, polyurethane, vinyl, and mixtures thereof.

23. The injection site of claim 21, wherein the septum is made of polyisoprene.

24. The injection site of claim 17, wherein the breakable zone is made of a material stiff enough to allow an easy breakage of the breakable tamper evident cap and ductile enough to prevent the formation of particles after the breakage.

25. The injection site of claim 17, wherein the top part, the center part and the insert part are molded into a single injection site.

26. The injection site of claim 17, wherein the top part, the center part and the insert part are separately molded and assembled into a single injection site.

27. The injection site of claim 17, wherein the top part comprises a fin attached to an outside surface of the first enclosure.

28. The injection site of claim 17, wherein the insert part comprises a fin attached to an outside surface of the third enclosure.

29. A medical device for transferring a fluid from a pharmaceutical flexible container, the medical device comprising:
a top part, the top part comprising:
a first enclosure enclosing a first housing for holding a septum, the first housing having a first opening at the top of the first housing; and
a membrane at the bottom of the first enclosure;
a lid, the lid sealing the first opening of the first housing; and
an insert part, the insert part comprising:
a second enclosure enclosing a first tunnel; and
a second opening at the top of the first tunnel, and a bottom surface of the membrane seals the second opening of the insert part.

30. The medical device of claim 29, wherein the septum is a self-sealing septum.

31. The medical device of claim 29, wherein the septum is made of an elastomeric material selected from the group consisting of polyisoprene, silicone, natural rubber, polychloroprene, nitrile, carboxylated acrylonitrile butadiene rubber, styrene butadiene rubber, butadiene co-polymer, polyurethane, vinyl, and mixtures thereof.

32. The medical device of claim 29, wherein the septum is made of polyisoprene.

33. The medical device of claim 29, wherein the top part, the lid and the insert part are molded into a single medical device.

34. The medical device of claim 29, wherein the top part, the lid and the insert part are separately molded and assembled into a single medical device.

35. The medical device of claim 29, wherein the insert part comprises a fin attached to an outside surface of the second enclosure.

36. A method for transferring a fluid from a pharmaceutical flexible container by using the medical device of claim 1, the method comprising:
connecting the medical device with the pharmaceutical flexible container;
breaking the top part of the medical device;
piecing a needle of a syringe through the septum; and
transferring the fluid from the pharmaceutical flexible container.
